(19) United States
(12) Patent Application Publication
(10) Pub. No.: US 2021/0405591 A1
(43) Pub. Date: Dec. 30, 2021

(54) INFORMATION TERMINAL DEVICE

(71) Applicant: KABUSIKIGAISYA DIGIMED, Wakayama (JP)

(72) Inventor: Kaisyou Hoshibata, Wakayama (JP)

(21) Appl. No.: 17/293,009

(22) PCT Filed: Aug. 30, 2019
(86) PCT No.: PCT/JP2019/034062

§ 371 Date: May 11, 2021

(30) Foreign Application Priority Data
Nov. 30, 2018 (JP) 2018-225269

(51) Int. Cl. G04G 17/04; G04G 17/08; G06F 1/16

(52) U.S. Cl. CPC G04G 17/045; G06F 1/163; G06F 1/1652; G04G 17/08

(57) ABSTRACT

An information terminal device of the present invention is a wristwatch type information terminal device provided with a storage tube on one side portion of a body, and is provided with a mechanism or the like that stores a film-shaped input/output portion in the storage tube in a wound up state, allows the input/output portion to be drawn out and extended through a slit, and reels in the input/output portion as appropriate. The input/output portion is lined with, or is enclosed in a frame of, a shape-memory alloy, thereby holding the input/output portion in an extended state (so as not to curl) when the input/output portion is drawn out from the body.

### TECHNICAL FIELD

The present invention relates to an information terminal device, and particularly to a wristwatch type information terminal device.

### BACKGROUND ART

As semiconductors have become more advanced, it has become possible for wristwatch sized devices to have various functions. An example of this is a device that can switch from displaying the time as a watch to being used as a pedometer, and may have a variety of functions with which biological information can be acquired such as heart rates, blood pressure, and blood oxygen levels. However, information that is currently acquired in such a way is difficult to manage, that is to say that the information is merely acquired and difficult to use, and is actually transferred to a smartphone to be used.

Also, as another example, there are also devices that are wristwatch sized and function as wearable terminals. For example, there are devices that include functions such as giving notifications when an email is received, and displaying small portions of email at a time. However, the capabilities of such devices are limited due to the screen, or in other words due to limitations of the size of the watch dial. For example, it is difficult to read long emails and perform advanced display of information such as web browsing on such screens, and it is also difficult to perform input operations such as operating touch panels viewed on such display screens.

Patent Document 1 proposes a wristwatch that can switch between clock display modes, displaying photographs, and the like through a scrolling operation performed via a touch panel.

### CITATION LIST

### Patent Document

Patent Document 1: JP 5572704B

### DISCLOSURE OF INVENTION

### Problem to be Solved by the Invention

With Patent Document 1, displaying various screens and touching the screens to make selections thereon can be performed on a watch dial portion, but there are functional restrictions to this because the display and input operations are performed within the scope of the watch dial, which is limited.

An object of the present invention is to provide a wristwatch type information terminal device with which it is possible to realize high-level functionality and/or multi-functionality.

### Means for Solving Problem

In order to realize the objective outlined above, a wristwatch type information terminal device of the present invention is provided with a storage tube on a side portion of the body other than the portions thereof to which a band is attached, and a film-shaped input/output portion that realizes a portion of display and/or input operations is drawn out from the storage tube for use.

Therefore, in a state in which the film-shaped input/output portion is extended in a band-like shape over the back of a hand or palm, or over an arm, the film-shaped input/output portion can realize high-level functionality and/or multi-functionality as an information terminal device due to realizing a portion of display and/or input operations as the information terminal device.

In order to realize the objective outlined above, another wristwatch type information terminal device of the present invention is configured such that the long film-shaped input/output portion that realizes display and/or input operations is drawn out and used from one side portion of the body other than the portions thereof to which a band is attached, is supported from the back surface thereof at a portion that corresponds to the common watch dial on the front plane of the body, is wound around a drum that freely rolls in the lengthwise direction in an inner portion of a housing portion, is gently returned to the housing portion, and is fed from the housing portion to the front plane via an arc-shaped guiding means.

Therefore, the film-shaped input/output portion can be smoothly deployed and housed with use of the drum and the arc-shaped guiding means without the input/output portion being folded. Thus, in a state in which the film-shaped input/output portion is extended in a band-like shape over the back of a hand or palm, or over an arm, the input/output portion can realize high-level functionality and/or multi-functionality as an information terminal device due to realizing at least a portion of display and/or input operations as an information terminal device.

### BRIEF DESCRIPTION OF DRAWINGS

FIG. 1 is a perspective view of a wristwatch type information terminal device according to a first embodiment of the present invention, and shows the state thereof when used as a wristwatch.

FIG. 2 is a perspective view of the wristwatch type information terminal device according to the first embodiment of the present invention, and shows the state thereof when used as an information terminal device.

FIG. 3 is a perspective view of the wristwatch type information terminal device according to a second embodiment of the present invention.

FIG. 4 is a perspective view of the wristwatch type information terminal device according to a third embodiment of the present invention, and shows the state thereof when used as a wristwatch.

FIG. 5 is a perspective view of the wristwatch type information terminal device according to the third embodiment of the present invention, and shows the state thereof when used as an information terminal device.

FIG. 6 shows cross-sectional views of FIG. 4 and FIG. 5.

FIG. 7 is a schematic cross-sectional view of another example of FIG. 6.

FIG. 8 is a perspective view of the wristwatch type information terminal device according to a fourth embodiment of the present invention, and shows the state thereof when used as a wristwatch.

FIG. 9 is a perspective view of the wristwatch type information terminal device according to the fourth embodiment of the present invention, and shows the state thereof when used as an information terminal device.

FIG. 10 is a cross-sectional view of FIG. 8.

### DESCRIPTION OF THE INVENTION

### First Embodiment

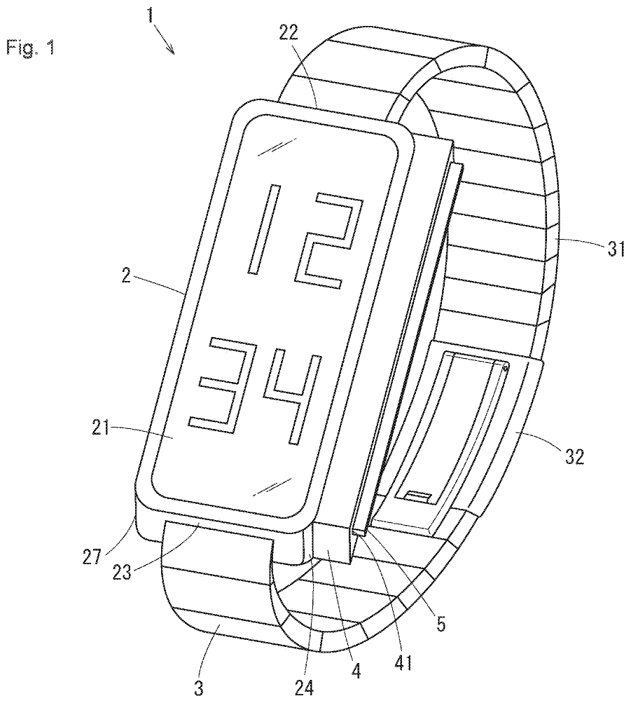

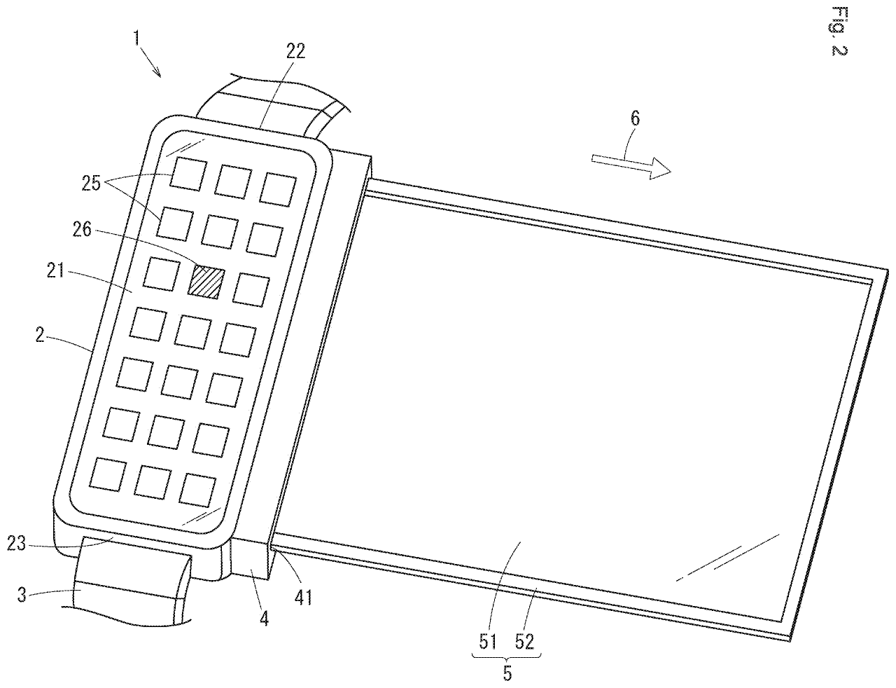

FIGS. 1 and 2 are perspective views of a wristwatch type information terminal device 1 according to a first embodiment of the present invention. FIG. 1 shows the state of the information terminal device 1 when used as a wristwatch, and FIG. 2 shows the state of the information terminal device 1 when used as an information terminal device.

The information terminal device 1 includes a body 2 having the basic functionality of a wristwatch type information terminal device and a band 3 that extends from the body 2, as well as a storage tube 4 and an input/output portion 5 stored therein according to the present invention. The body 2 is rectangular and elongated in the circumferential direction of a wrist. In the example shown in FIG. 1, a watch dial portion 21 is displaying the time of 12:34. Other than the time shown, the character panel portion 21 may also appropriately display seconds, dates, days of the week, calendars, and the like, and may also display steps, blood pressure and heart rates measured by a biosensor (not shown), or the like on the face portion 21 by changing the display mode. Basically, switching between such display modes and the like is performed through a touch sensor or the like provided on the watch dial portion 21, but may also be appropriately performed with the use of a knob, a button, or the like provided on a side portion or the like of the body 2.

Also, the band 3 is a wrist-band and is formed extending from an upper portion (top portion) 22 and a lower portion (bottom portion) 23 of the body 2. In the example shown in FIG. 1, the band 3 is shown as a metal band that includes segments 31 and a retaining portion (buckle) 32, but the band may also be a leather or resin band, and may also be an open-type band whose length can be adjusted and fixed with a buckle and a prong.

Note that the information terminal device 1 of the present embodiment is provided with the storage tube 4 and the input/output portion 5 on one side portion 24 of the body other than the portions thereof to which the band 3 is attached. In the examples shown in FIG. 1 and FIG. 2, the storage tube 4 extends as straightly as is possible in the circumferential direction of the wrist and is provided on the one side portion 24, which is on the right hand side of the body 2. Also, the film-shaped input/output portion 5 is configured to be stored inside of the storage tube 4 in a wound up state as shown in FIG. 1, and extended by being drawn out in the direction indicated by an arrow 6 in FIG. 2 from a slit 41 formed in the axial direction of the storage tube 4.

In the extended state shown in FIG. 2, the input/output portion 5 can realize a portion of display and/or input operations as an information terminal device. In the example shown in FIG. 2, the watch dial portion 21 of the body 2 shows a selection screen that displays a plurality of icons 25 that each represent an application program and if, for example, an icon 26 shown by hatching is selected, the content of the selected and initiated application program is displayed on the input/output portion 5. Selecting an application program may also be performed by scrolling through a list of programs and files and making a selection, like selecting songs in a music player, rather than by operating an icon.

The input/output portion 5 includes a body 51 that includes a transparent touch panel sensor attached to the film-shaped display device, and a frame 52 that constitutes the outer peripheral portion of the input/output portion 5. The film-shaped display device can be realized with electronic paper, an organic EL film display, or the like. In the case of an organic EL film display, a resin substrate organic EL film display is preferable. The frame 52 is made from a shape-memory alloy, and extends in a pole-shape by being drawn out from the storage tube 4 and is self-supporting. Thus, the input/output portion 5 that had been wound up is also held in a spread-out state, and it becomes easier to check the screen, and also easier to perform touch operations. Instead of the frame 52, the underside of the film-shaped display device may also be lined with a shape-memory alloy that keeps the display device flush, in order to spread out and hold the input/output portion 5.

In the storage tube 4, an end portion of the input/output portion 5 is fixed to a winding shaft. Communication between the input/output portion 5 and a signal processing circuit or the like in the main body 2 is performed by a flexible substrate or the like via the winding shaft or the like. The winding shaft is provided with a locking mechanism (not shown) such as the mechanism used with blinds, and when the entire length of the input/output portion 5 is drawn out, the input/output portion 5 is locked in the drawn-out state, and drawing out the input/output portion 5 once more releases the lock and allows the input/output portion 5 to be wound up.

Due to the advancement of semiconductors, wristwatch type information terminal devices currently have no problem with receiving emails, web browsing, or the like as functions that can be embedded in a device the size of a wristwatch. However, wristwatch type information terminal devices cannot yet sufficiently realize display and/or input operations in ways that are similar to those of a tablet terminal, for example. Such display and/or input operations are difficult to perform with just the screen area of the watch dial 21, and the functions that can be realized thereby are currently limited. Examples of this include not being able to read the entire text of an email.

In contrast to this, the information terminal device 1 of the present embodiment is provided with the storage tube 4 in the one side portion 24 of the body 2, and is provided with a mechanism or the like that stores the film-shaped input/output portion 5 in the storage tube 4 in a wound up state, allows the input/output portion 5 to be drawn out and extended from the slit 41, and reels in the film shaped input/output portion 5 as appropriate. Thus, if the screen area of the watch dial portion 21 is 1.9 inches for example, the screen can be made three times larger with use of the input/output portion 5 and become a 5.7 inch screen, which is the size of the screen of a small smartphone.

Accordingly, in a state in which the film-shaped input/output portion 5 is extended in a band-like shape over the palm or back of a hand (when drawn out towards the linger-side as shown in FIGS. 1 and 2), or over an arm (when drawn out towards the elbow-side, which is the opposite direction to that shown in FIGS. 1 and 2), the film-shaped input/output portion 5 can realize at least a portion of display and/or input operations as an information terminal device. Thus, the information terminal device 1 can realize high-level functionality and/or multi-functionality. For example, it becomes easier to post on and browse social networking services such as LINE (registered trademark) and Twitter (registered trademark) even with the wristwatch type information terminal device 1.

The body 2 may also be configured to connect to (access) a mobile telephone network and obtain the content of an application program, such as news or emails. Also, in order to acquire the content of such an application program, or in order to communicate with a smartphone that is a master device, the body 2 may also connect to the network or smartphone via a short-range wireless LAN network such as so-called Wi-Fi (registered trademark, IEEE 802.11 standard) or Bluetooth (registered trademark, IEEE 802.15 standard).

Note that the band 3 is not limited to a band or belt as shown in FIGS. 1 and 2 that extends the entire circumference of a wrist and wraps therearound, and may also be a bracelet-shaped member that is formed as a single piece with the body 2, and does not need to wrap around the entire circumferential direction of the wrist in such a case (a portion thereof may also be cut).

Also, the information terminal device 1 of the present invention may use thin and flexible electronic paper for the display of the input/output portion 5, which is suitable as a film-shaped input/output portion that can be drawn out and extended through the slit 41 from a state of being wound up in the storage tube 4. Alternatively, a thin and flexible resin substrate organic EL film display that is thinner and more flexible than other organic EL film displays may be used for the display of the input/output portion 5, which is suitable as a film-shaped input/output portion that can be drawn out and extended through the slit 41 from a state of being wound up in the storage tube 4. Note that wristwatches that change the patterns on the watch dial by using electronic paper as the watch dial have been commercialized, but such wristwatches only change of the watch dial and do not include the auxiliary input/output portion 5 of the present embodiment.

Furthermore, the wristwatch type information terminal device 1 of the present embodiment displays an application program selection screen, such as the icons 25, on the small body 2 and displays detailed content of the selected application program on the large input/output portion 5, and can therefore handle a wide range of application programs despite being a wristwatch type information terminal device.

Also, with the wristwatch type information terminal device 1 of the present embodiment, the film-shaped input/output portion 5 that is configured to be stored in the storage tube 4 in a wound up state may be lined with a shape-memory alloy or, as shown in FIG. 2, may include a frame enclosure (52), and can therefore be held in an extended state (that does not curl) in which the input/output portion 5 is drawn out, and thus it is not necessary for a user to hold the input/output portion 5 in the drawn out state thereof.

### Second Embodiment

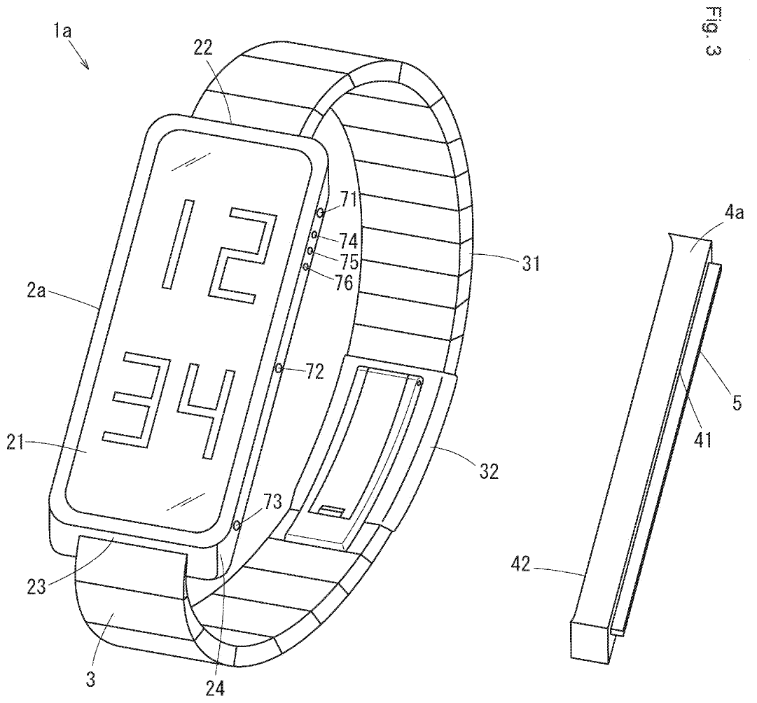

FIG. 3 is a perspective view of a wristwatch type information terminal device 1a according to a second embodiment of the present invention. The information terminal device 1a is similar to the information terminal device 1 shown in FIGS. 1 and 2, and the same reference numerals denote the corresponding portions with descriptions thereof omitted. Note that in the information terminal device 1a, a storage tube 4a and the input/output portion 5 stored therein can be detached from, and attached to, the one side portion 24 of a body 2a. By doing so, the film-shaped input/output portion 5 can be used as an increased input/output portion on which the screen area of the watch dial portion 21 is made larger when in the extended state shown in FIG. 2, and the design of the body 2a of the wristwatch type information terminal device 1a can be improved by removing the storage tube 4a and the input/output portion 5 when not needed.

In the example shown in FIG. 3, the storage tube 4a can be detached from, and attached to, the body 2a with the use of magnets, and the one side portion 24 of the body 2a is provided with three magnets or magnetic bodies 71, 72, and 73 that are provided at roughly equal intervals. Correspondingly, a side surface 42 of the storage tube 4a is also provided with magnets or magnetic bodies. As the magnets and magnetic bodies, both the body 2a and the storage tube 4a may be provided with magnets of opposite polarities that are attracted to each other, or one of the body 2a and the storage tube 4a may be provided with magnets and the other provided with magnetic bodies such as steel plating that is attracted to the magnets.

Also, the one side portion 24 of the body 2a is provided with linking contact points 74, 75, and 76, and corresponding interlocking switches are provided on the side surface 42 of the storage tube 4a. For example, the linking contact points 74 and 76 may be used to supply power, and the linking contact point 75 may be used for communication. In this case, the input/output portion 5 side requires an integrated circuit for driving the display device, touch panel sensor, and the like of the body 51, but a configuration is also possible in which the number of contact points is increased and the display device, touch panel sensor, and the like are directly driven from the body 2 and thus the body 51 is not provided with special circuitry.

Strong neodymium magnets are suitable as the magnets or magnetic bodies 71, 72, and 73, so that the linking contact points 74, 75, and 76 do not detach due to shock or the like. Also, in order to avoid unwanted detachment, configurations are preferable in which the storage tube 4a is detachable from, and attachable to, the body 2a with the use of a screw, or in which the storage tube 4a and the body 2a include protrusions and recessions which engage with each other and allow slidable attachment and detachment thereof.

### Third Embodiment

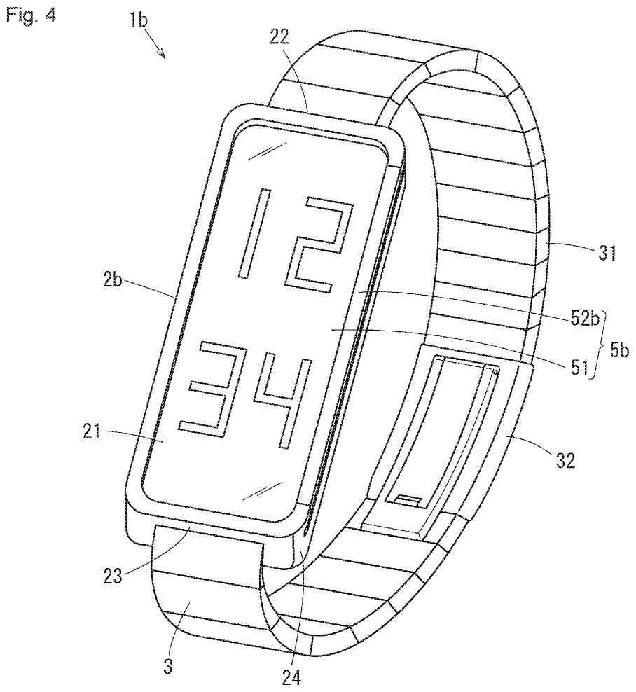

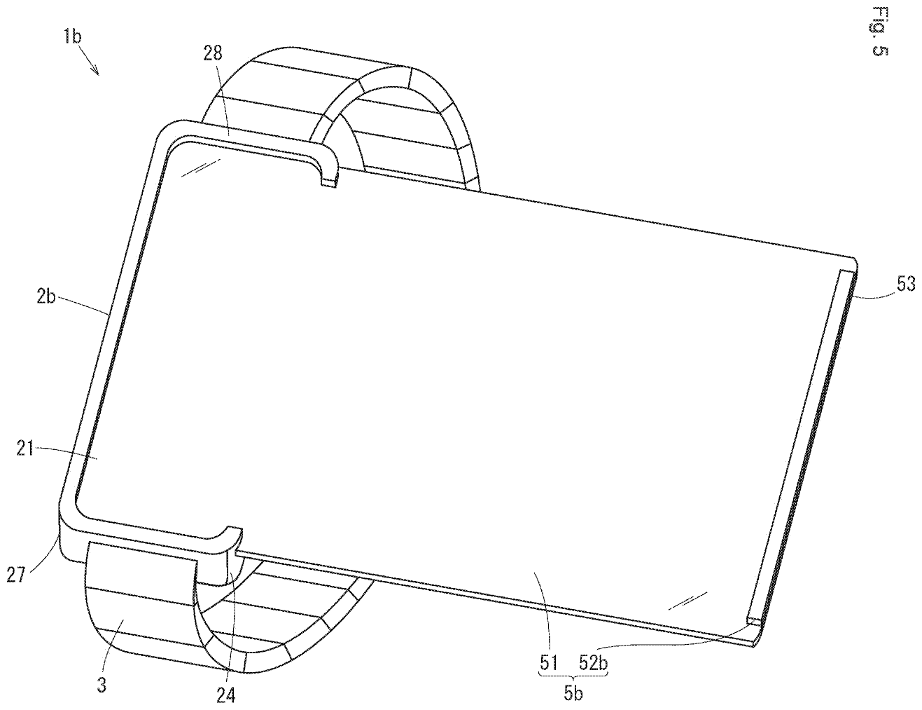

FIGS. 4 and 5 are perspective views of a wristwatch type information terminal device 1b according to a third embodiment of the present invention. Similarly to FIGS. 1 and 2, FIG. 4 shows the state of the information terminal device 1b when used as a wristwatch, and FIG. 5 shows the state of the information terminal device 1b when used as an information terminal device. The information terminal device 1b is similar to the information terminal device 1 shown in FIGS. 1 and 2, and the same reference numerals denote the corresponding portions, with descriptions thereof omitted.

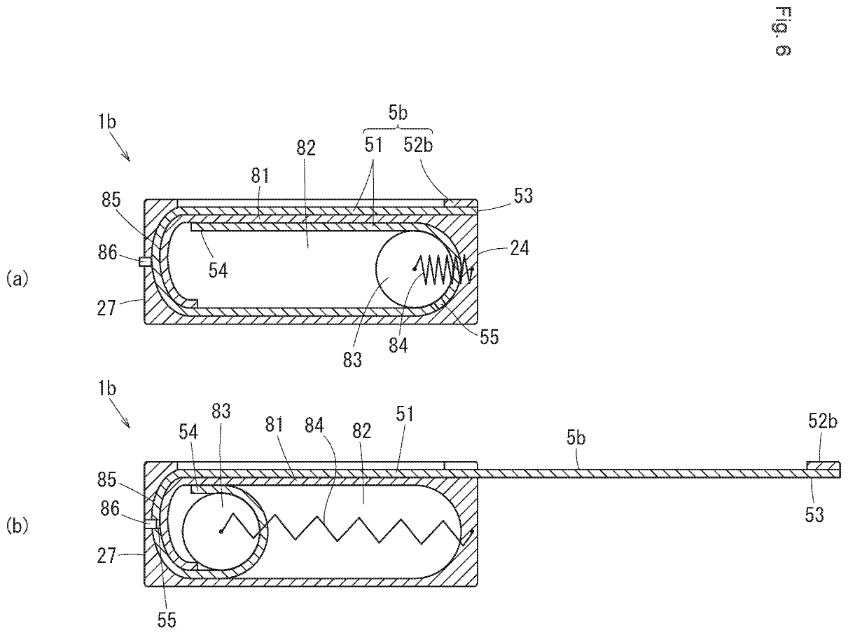

Note that in the information terminal device 1b, an input/output portion 5b is housed in a body 2b and not in the storage tube 4 described above, and is drawn out from the one side portion 24 of the body 2b. FIG. 6 is a cross-sectional view of the information terminal device 1b, FIG. 6 (a) shows the information terminal device 1 when used as a wristwatch as shown in FIG. 4, that is to say when the input/output portion 5b is housed, and FIG. 6 (b) shows the information terminal device 1b when used as an information terminal device as shown in FIG. 5, that is to say a state in which the input/output portion 5b is drawn out. The input/output portion 5b is constituted by a rigid frame 52b that is attached to a free end portion 53 of the body 51 that is formed in a long film shape.

On the other hand, the body 2b includes a support member 81 that supports the input/output portion 5b from the back surface thereof in the common watch dial 21 at the front face, and the input/output portion 5b is configured to be drawn out from the above-described one side portion 24 side of the support member 81. Also, the inside of the body 2b includes a housing portion 82 that is configured to bend the input/output portion 5b in the lengthwise direction and house the bent input/output portion 5b. The inside of the housing portion 82 is provided with a drum 83 that rolls freely in the lengthwise direction and is configured to have the input/output portion 5b wound around the outer periphery thereof, and the housing portion 82 is also provided with a biasing means 84 that applies tensile force to the drum 83 in the direction in which the wound input/output portion 5b is drawn in. The housing portion 82 has a long oval shape in a cross-sectional view thereof that allows the drum 83 to roll. The biasing means 84 is a tension spring in the example shown in FIG. 6.

In the example shown in FIG. 6 specifically, a base end portion 54 of the input/output portion 5b is fixed to the back surface side of the support member 81 in the housing portion 82 on another side portion 27 side of the body 2b, and is connected to circuitry on the body 2b side. After the input/output portion 5b is retracted along the back surface portion of the support member 81 towards the one side portion 24, is wound around the drum 83, and the direction thereof is changed, the input/output portion 5b is drawn back towards the other side portion 27, and is guided by an arc-shaped guiding means 85 from the opening of the housing portion 82 to the front surface side of the support member 81 as described above. Thus, the drum 83 is biased towards the one side portion 24 by the biasing means 84, and therefore the input/output portion 5b is drawn back as shown in FIG. 6 (a) and the free end portion 53 side of the input/output portion 5b is exposed at the front face of the body 2b. That is to say that display and/or input operations are then performed with only the watch dial portion 21. In contrast, if the input/output portion 5b is drawn out as shown in FIG. 6 (b) against the biasing force of the biasing means 84, the base end portion 54 side of the input/output portion 5b faces the front plane and the input/output portion 5b is extended into a long shape and forms a continuous screen without any discontinuity.

Also, the body 2b is provided with a locking means 86 that prevents the input/output portion 5b from being drawn in due to the biasing means 84 as shown in FIG. 6 (b) where the input/output portion 5b is completely drawn out. In the example shown in FIG. 6, the locking means 86 is a pin that engages with a hole 55 formed in the body 51 when the input/output portion 5b is in the drawn-out state thereof.

By being configured in this way, the film-shaped input/output portion 5b can be smoothly deployed from the other side portion 27 of the body 2b and housed therein with use of the drum 83 and the arc-shaped guiding means 85 without the input/output portion 5b being folded. Thus, in a state in which the film-shaped input/output portion 5b is extended in a band-like shape over the palm or back of the hand (when drawn out towards the finger-side), or over the arm (when drawn out towards the elbow-side), the film-shaped input/output portion 5b can realize high-level functionality and/or multi-functionality as an information terminal device due to realizing at least a portion of display and/or input operations as the information terminal device.

Also, in order to guide the input/output portion 5b when drawn out and drawn back, an edge of the film-shaped body 51 of the input/output portion 5b is supported by a window frame 28. The window frame 28 makes the watch dial portion 21 an open window and supports three areas, namely both side portions of the body 51 in the width-direction thereof, and the other side portion 27 side (the opening side of the guiding means 85) of the body 2b, and is continuous with the remaining area that forms the frame 52b when the input-output portion 5b is in the housed state shown in FIG. 6 (a). Due to the window frame 28 not being provided on (cut from) the one side surface 24 side, the input/output portion 5b that has been drawn out as shown in FIG. 6 (b) can, as described above, form a continuous screen from the base end portion 54 side to the free end portion 53 side. Thus, the input/output portion 5b can form a continuous screen from the base end portion 54 positioned on the front plane side to the portion of the input/output portion 5b towards the free end portion 53 that is drawn out over the palm of the hand or the like, and can thereby enrich the display of content. The frame 52b serves as a handle when drawing out the input/output portion 5b.

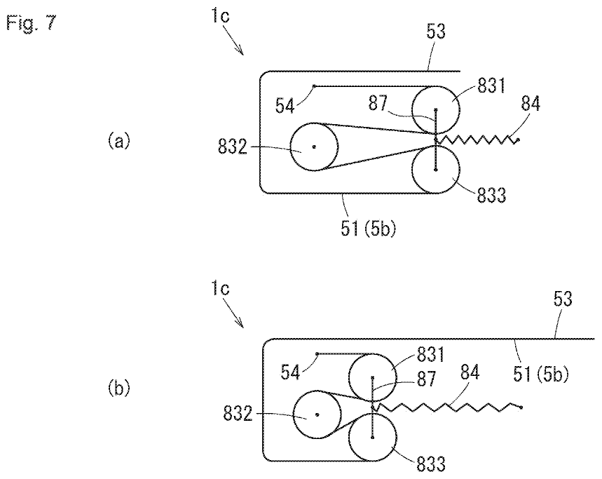

Here, the information terminal device 1b described above included one drum 83, but the greater the number of drums provided, the greater the length of the input-output portion 5b that can be deployed while keeping the same width for the body 2b. In view of this, as shown in an information terminal device 1c in FIG. 7, a plurality of drums 83 may also be provided. FIGS. 7 (a) and 7 (b) are schematic cross-sectional views of FIGS. 6 (a) and 6 (b), respectively. In the example shown in FIG. 6, there are three drums 831, 832, and 833 that are arranged spaced apart in the thickness direction of the housing portion 82, and the input/output portion 5b is wound therebetween in a zig-zag manner. The rotational axes of the drums 831 and 833 on the one side portion 24 side are coupled to each other by a bar 87, and the biasing means 84 is coupled to the bar 87. The drum 832 on the opposing other side portion 27 side does not roll, but only rotates around a rotary shaft that is pivoted at a fixed position.

In the example shown in FIG. 7, the three drums 831, 832, and 833 are not aligned vertically, that is to say that as shown in FIG. 7 (b), the three drums 831, 832, and 833 are not aligned in a single line in the thickness direction of the housing portion 82 even in a state in which the entire length of the input/output portion 5b is deployed, and the middle drum 832 is arranged at a height between the rotational axes of the upper drum 831 and the lower drum 833. Accordingly, while the deployment length of the input/output portion 5b is slightly shortened, the thickness of the body 2b can be made thinner in the vicinity of the drum 832.

Also, configurations are possible in which a frame 52b is held by a multi-stage frame that is configured to be deployed from the one side portion 24 of the body 2b similarly to a telescope or a retractable ladder of a ladder truck, such that the film-shaped input/output portion 5b is kept flat.

### Fourth Embodiment

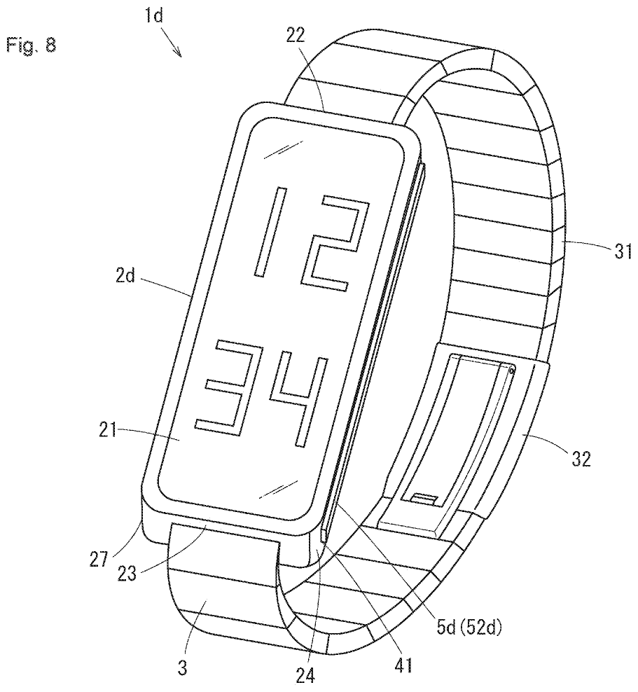

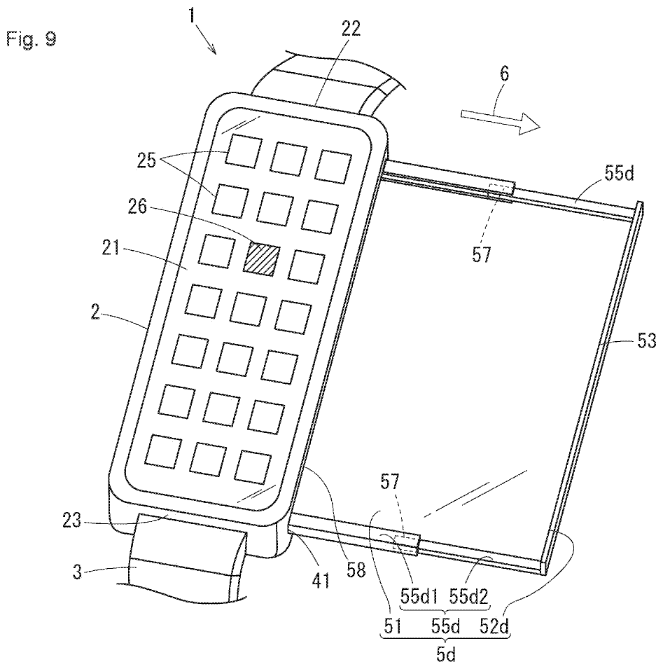

FIGS. 8 and 9 are perspective views of a wristwatch type information terminal device 1d according to a fourth embodiment of the present invention. FIG. 8 shows the state of the information terminal device 1d when used as a wristwatch, and FIG. 9 shows the state of the information terminal device 1d when used as an information terminal device. The information terminal device 1d is similar to the information terminal device 1 described above, and the same reference numerals denote the corresponding portions with descriptions thereof omitted. The information terminal device 1d includes a body 2d having the basic functionality of an information terminal device, the band 3 that extends from the body 2d, and an input/output portion 5d according to the present embodiment that is configured to be housed in the body 2d.

Note that with the information terminal device 1d of the present embodiment, the watch dial portion 21 forms a first input/output portion, the input/output portion 5d forms a second input/output portion that is configured to be drawn out from a portion of the one side portion 24 (rightward in FIGS. 8 and 9) of the body 2d other than portions thereof to which the band 3 is attached, and the input/output portion 5d can be drawn out and extended in the direction indicated by an arrow 6 in FIG. 9. Thus, the watch dial portion 21 is provided on the front face of the body 2d and realizes display and/or input operations as an information terminal device, and the input/output portion 5d is formed in a long film-shape and realizes a portion of display and/or input operations as the information terminal device.

In the example shown in FIG. 9, the watch dial portion 21 of the body 2d is a selection screen on which the plurality of icons 25 that each represent an application program are shown and, for example, if the icon 26 shown by hatching is selected, the content of the selected and initiated application program is displayed on the input/output portion 5d. Selecting an application program may also be performed by scrolling through a list of programs and files and making a selection, like selecting songs in a music player, rather than by operating an icon.

The input/output portion 5d includes: the body 51 that includes a transparent touch panel sensor attached to the film-shaped display device; a rigid frame 52d that is attached to the free end portion 53 (one end portion) of the body 51, forms a first frame, and extends in the width direction; and a pair of frames 55d that respectively hold end portions of the frame 52d, are configured to be deployed from the one side portion 24 of the body 2d, and form the second frame. The film-shaped display device can be realized with electronic paper, an organic EL film display, or the like. In the case of an organic EL film display, a resin substrate organic EL film display is preferable.

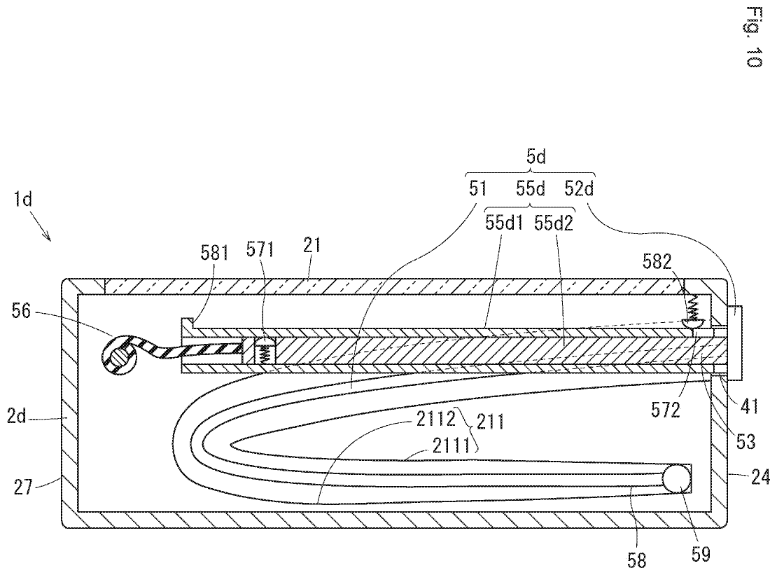

FIG. 10 is a cross-sectional view of the information terminal device 1d that shows the information terminal device 1d when used as the wristwatch in FIG. 8, that is to say when the input/output portion 5d is housed. A storage portion 211 for the input/output portion 5d is provided on the backside (underside) of the watch dial portion 21 in the body 2d, and the storage portion 211 has an approximately U-shaped bend in a cross-sectional view in the lengthwise direction of the arm of the user who is wearing the information terminal device 1d. The storage portion 211 is formed by the space between an inner wall surface 2111 and an outer wall surface 2112 of the “U” shape, and the storage portion 211 bends and houses the long film-shaped input/output portion 5d. Both end sides of the “U” shape of the storage portion 211 face the one side portion 24, and the bent portion of the storage portion 211 faces the other side portion 27, where one end portion of the “U” shape is formed by the slit 41 from which the input/output portion 5d can be drawn out, and the other end portion is closed. The slit 41, and accordingly the body 2d, is formed extending as straightly as possible in the circumferential direction of the wrist of the user in order to maximize the width of the input/output portion 5d, that is to the height of the screen.

On the one side portion 24 of the body 2d, the frames 55d are provided as a pair respectively on the two end portion sides of the slit 41, and the frames 55d are formed so as to be able to protrude/retract from the one side portion 24 in a similar manner to that of a telescope or the retractable ladder of a ladder truck. In the example shown in FIGS. 9 and 10, the frames 55d are constituted by two frames, with a first-stage frame 55d1 on the one side portion 24 side having a C-channel shape in a cross-sectional view thereof, and a second-stage frame 55d2 on the free-end side having a belt-shape that is fitted into, and stored in, the gap of the C-channel of the first-stage frame 55d1. However, as previously described, the free end portion 53 (one end portion) of the long film-shaped body 51 being coupled to the frame 52d allows the frames 55d to be stored in a body that is separate to the body 51 in a state in which the frames 55d are stored in the body 2d, as shown in FIG. 10. In other words, both end portions of the long film-shaped body 51 of the input/output portion 5d in the width direction thereof (the edge portions of the top and bottom of the screen) are not especially held, and therefore a rectangular tube or a cylindrical tube may be used for the frames 55d in order to increase the strength thereof, and it is sufficient that the frames 55d are formed so as to be able to protrude/retract in a similar manner to that of a telescope or the retractable ladder of a ladder truck.

Furthermore, the retracting-side end portion of the leading-end stage frame (the second-stage frame 55d2) of the multi-stage frames 55d is coupled to an elastic member 56 that is used to draw back the frames 55d. The elastic member 56 is made from a rubber, a spring, or the like. If the second-stage frame 55d2 is fully retracted (stored) when the input/output portion 5d is to be retracted (stored) after use, the multi-stage frames 55d, which can protrude/retract in a similar manner to that of a telescope or the retractable ladder of a ladder truck, are configured to be automatically fully drawn in (stored), thus making it possible to improve operability.

On the other hand, a locking means is provided between the body 2d and the first-stage frame 55d1, or between the first-stage frame 55d1 and the second-stage frame 55d2, such that the frames 55d are not undesirably drawn in by the biasing force from the elastic member 56 that is made from rubber, a spring, or the like and is used to draw back the frames 55d. In the example in FIG. 2, the first-stage frame 55d1 and the second-stage frame 55d2 are provided with a locking means where either the first-stage frame 55d1 or the second-stage frame 55d2 is provided with a locking projection 571, and the other one is provided with a locking recession 572. A locking means provided between the body 2d and the first-stage frame 55d1 is realized with a locking claw 581 and a locking projection 582 (the back surface of the locking claw 581 is caught by the locking projection 582 when the frame 55d is drawn out). The frames 55d are drawn into the body 2d by the elastic member 56 by releasing the locks of these locking means. The locking means may be appropriately chosen according to the required engagement force, installation space, and the like, and may be a simple protrusion and recession that disengage from each other when a force of a certain strength or stronger is applied thereto, or may be a hook and a recession that requires a specific unlocking operation. Also, falling-prevention (removal prevention) stoppers are included, with the body 2d having a stopper that abuts with the first-stage frame 55d1, and first-stage frame 55d1 having a stopper that abuts with the second-stage frame 55d2, and a common object may be used for the stoppers (in FIG. 3, the locking claw 581 is used in combination with a stopper).

Also, another end 58 side of the long film-shaped body 51 is provided with a wheel 59 that has a larger radius than that of the slit 41 and that slides in the bend of the storage portion 211. The wheel 59 guides the other end 58 between the wall surfaces 2111 and 2112, and can stop the other end 58 from coming loose from the slit 41 of the body 51. Note that it is not absolutely necessary for the wheel 59 to rotate, and a ball may also be used that does not become caught in the bent portion of the U-shaped bend. Thus, in a state in which the frames 55d are completely drawn out, the long film-shaped body 51 is kept in a spread-out state with a constant tensile force, it becomes easy to check the screen of the body 51, and it is also becomes easy to perform touch operations on the body 51.

The electrical connection between the body 51 of the input/output portion 5d and the body 2d may be performed, for example, by a flexible substrate connected to the other end 58 of the body 51, or by a plurality of connection points provided on the other end 58 and the input/output portion 5d coming into contact with the connection points corresponding to the inner sides of the slit 41 when the input/output portion 5d is fully drawn out.

As described above, with the information terminal device 1d of the present embodiment, the common watch dial portion 21 provided in the front plane of the body 2d serves as the first input/output portion, and the long film-shaped second input/output portion 5d, which realizes a portion of display and/or input operations, can be drawn-out and used from the one side portion 24 of the body 2d. Thus, the film-shaped input/output portion 5d can be smoothly deployed from the one side portion 24 of the body 2d and housed therein with use of the storage portion 211 made from the U-shaped bend and the wheel 59 that slides therein, without the film-shaped input/output portion 5d being folded. In this way, in a state in which the film-shaped input/output portion 5d is extended in a band-like shape above the palm or the back of the hand (when drawn out towards the finger-side), or over the arm (when drawn out towards the elbow-side), the film-shaped input/output portion 5d can realize high-level functionality and/or multi-functionality as an information terminal device due to realizing at least a portion of display and/or input operations as the information terminal device. If the screen area of the watch dial portion 21 is 1.9 inches, for example, the screen can be made three times larger with use of the input/output portion 5d and become a 5.7 inch screen, which is the size of the screen of a small smartphone. Thus, it becomes easier to post on and browse social networking services such as LINE (registered trademark) and Twitter (registered trademark) even with the wristwatch type information terminal device 1d for example.

Also, the information terminal device 1d of the present embodiment may use thin and flexible electronic paper for the display of the input/output portion 5d, and is therefore suitable as a film-shaped input/output portion that can be drawn out and extended through the slit 41 from a state of being bent in the storage portion 211. Alternatively, a thin and flexible resin substrate organic EL film display that is thinner and more flexible than other organic EL film displays may be used for the display of the input/output portion 5d, and is therefore suitable as a film-shaped input/output portion that can be drawn out and extended through the slit 41 from a state of being bent in the storage portion 211. Note that wristwatches that change the patterns on the watch dial by using electronic paper as the watch dial have been commercialized, but such wristwatches only change of the watch dial and do not provide the auxiliary input/output portion 5d of the present embodiment.

Furthermore, the wristwatch type information terminal device 1d of the present embodiment displays an application program selection screen, such as the icons 25 on the small body 2d, and displays the detailed content of the selected application programs on the large input/output portion 5d, and can therefore handle a wide range of application programs despite being a wristwatch type information terminal device.

The wristwatch type information terminal device of the present invention includes a storage tube provided on one side portion of the body other than the portions thereof to which the band is attached, and a film-shaped input/output portion that is stored in a wound up state in the storage tube, which can be extended by being drawn out from a slit formed in the storage tube in the axial direction thereof, realizes a portion of display and/or input operations as the information terminal device in the extended state.

The wristwatch type information terminal device can realize this objective with a watch display that has the size of a common watch dial. However, it is difficult to satisfactorily realize display and/or input operations as an information terminal device with only the screen area of the watch dial, which restricts the functions that can be realized with current wristwatch type information terminal devices. With the present invention, as with the configuration described above, a film-shaped input/output portion that realizes a portion of display and/or input operations can be drawn-out and used from one end portion of the body other than the portions thereof to which the band is attached. Specifically, the one side portion is provided with the storage tube that extends as straightly as possible in the circumferential direction of the wrist, and the film-shaped input/output portion is stored in the storage tube in a wound up state. The storage tube includes the slit formed therein in the axial direction thereof, and is provided with a mechanism or the like that allows the film-shaped input/output portion to be drawn out and extended from the slit, and reels in the film-shaped input/output portion as appropriate.

Accordingly, in a state in which the film-shaped input/output portion is extended in a band-like shape above the palm or the back of the hand (when drawn out towards finger-side), or over the arm (when drawn out towards the elbow-side), the film-shaped input/output portion can realize high-level functionality and/or multi-functionality as an information terminal device by realizing a portion of display and/or input operations and the information terminal device.

Also, with the wristwatch type information terminal device of the present invention, the display of the input/output portion is realized with electronic paper.

With the configuration described above, the electronic paper is thin and flexible. Accordingly, this is suitable as a film-shaped input/output portion that can be drawn out and extended through the slit from a state in which the film-shaped input/output portion is wound up inside of the storage tube.

Furthermore, with the wristwatch type information terminal device of the present invention, the display of the input/output portion is realized with a resin substrate organic EL film display.

With the configuration described above, a resin substrate organic EL film display is thinner and more flexible than other organic EL film displays. Accordingly, this is suitable as a film-shaped input/output portion that can be drawn out and extended through the slit from a state in which the film-shaped input/output portion is wound up inside of the storage tube.

Also, with the wristwatch type information terminal device of the present invention, the application program selection screen is displayed on the body, and the content of the application program that has been selected and initiated on the selection screen is displayed on the input/output portion.

With the configuration described above, the application program selection screen, such as the icons, is displayed on the small body and the detailed content of the selected application program is displayed on the large input/output portion, and therefore the information terminal device can handle a wide range of application programs despite being a wristwatch type information terminal device.

Furthermore, with the wristwatch type information terminal device of the present invention, the film-shaped input/output portion is lined with, or is enclosed in a frame of, a shape-memory alloy.

With the configuration described above, the film-shaped input/output portion that is configured to be stored in the storage tube in a wound up state may be lined with or enclosed in a frame made of a shape-memory alloy, and therefore can be held in the extended state (that does not curl) in which the input/output portion is drawn out, and thus it is not necessary for a user to hold the input/output portion in the drawn out state.

Also, with the wristwatch type information terminal device of the present invention, the storage tube and the input/output portion that is configured to be stored therein can be detached from, and attached to, the one side portion of the body.

With the configuration described above, it is possible to use an input/output portion that can magnify the display region of the watch dial by increasing and extending the film-shaped input/output portion, the input/output portion can be removed when not needed, and the design of the body of the wristwatch type information terminal device can be improved.

Furthermore, a wristwatch type information terminal device of the present invention includes: an input/output portion that is formed in a long film-shape and realizes display and/or input operation as the information terminal device; a body that includes a housing portion that supports the input/output portion from a back surface thereof at a front face, allows the input/output portion to be drawn out from one side surface of the body, and bends the input/output portion in a lengthwise direction thereof and houses the bent input/output portion therein; a drum that is provided in the housing portion, can roll in the lengthwise direction, and is configured to have the input/output portion wound around the outer periphery thereof; a biasing means configured to apply tensile force to the drum in a direction in which the wound input/output portion is drawn in; an arc-shaped guiding means that is provided in the body and is configured to guide the input/output portion from the housing portion towards the front face; and a locking means configured to prevent the input/output portion from being drawn in due to the biasing means, in a state in which a base end portion of the input/output portion is drawn out from the housing portion via the guiding means until the base end portion faces a front side.

With the configuration described above, the long film-shaped input/output portion that realizes display and/or input operations can be drawn-out and used from one end portion of the body other than the portions thereof to which the band is attached. Specifically, the housing portion is provided that supports a portion of the long film-shaped input/output portion from the back surface thereof in the front plane of the body, at the portion thereof that corresponds to the common watch dial, allows the input/output portion to be drawn out from the one side surface of the body by the free end side thereof, and furthermore bends the input/output portion in the lengthwise direction thereof and houses the input/output portion in the housing portion.

Thus, the inside of the housing portion is provided with the drum that rolls freely in the lengthwise direction and is configured to have the long film-shaped input/output portion wound around the outer periphery thereof, and the storage portion is also provided with the biasing means that applies tensile force to the drum in the direction in which the wound input/output portion is drawn in. On the other hand, after the base end side of the long film-shaped input/output portion is fixed to the inside of the housing portion and the input/output portion is wound around the drum up to the free end side, the input/output portion is fed from the opening in the housing portion to the front plane via the arc-shaped guiding means. In this state, the display and/or input operations are performed when the free end of the long film-shaped input/output portion faces the watch dial, that is to say just with the watch dial.

In contrast, if the long film-shaped input/output portion is drawn out from the free end portion side thereof against the biasing force of the biasing means, the base end portion side of the input/output portion faces the front side, and it is then possible to form an increased input/output portion that extends to the free end portion side that has been drawn to the outside. The locking means is provided so that the long film-shaped input/output portion is not drawn in by the drum due to the biasing force of the biasing means when the input/output portion is completely drawn out.

Accordingly, the film-shaped input/output portion can be smoothly deployed and housed with use of the drum and the arc-shaped guiding means without the input/output portion being folded. Thus, in a state in which the film-shaped input/output portion is extended in a band-like shape above the palm or the back of the hand (when drawn out towards finger-side), or over the arm (when drawn out towards the elbow-side), the film-shaped input/output portion can realize high-level functionality and/or multi-functionality as an information terminal device by realizing a portion of display and/or input operations as the information terminal device.

Also, the wristwatch type information terminal device of the present invention according to claim 7 may be configured such that a window frame that forms an open window for exposing the input/output portion is provided in the front face, the window frame is not provided on the one side surface side, and the drawn out input/output portion forms a continuous screen from a base end portion side to a free end portion side.

With the configuration described above, the film-shaped input/output portion is supported by the window frame that forms the open window at the front face, and the window frame is cut at the one side surface side of the portion of the input/output portion that is drawn out.

Accordingly, the input/output portion can form a continuous screen from the base end portion positioned on the front plane side to the portion of the input/output portion towards the free end portion that is drawn out over the palm of the hand or the like, and can thereby enrich the display of content.

Furthermore, with the wristwatch type information terminal device of the present invention, a plurality of drums are provided so as to be spaced apart in the thickness direction of the body.

With the configuration described above, by bending the film-shaped input/output portion between the plurality of drums, it is possible to increase the length of the input/output portion to be housed in the housing portion, that is to say increase the length to which the input/output portion is to be deployed.

Also, a wristwatch type information terminal device of the present invention includes a first input/output portion that is provided at a front face of a body and realizes display and/or input operations as the information terminal device; a second input/output portion that is formed in a long film-shape and realizes a portion of display and/or input operations as the information terminal device; a storage portion that is provided in the body on a back side (underside) of the first input/output portion, has an approximately U-shaped bend in a cross-sectional view in a lengthwise direction of an arm, is configured to house the second input/output portion in the bend, and enables the second input/output portion to be drawn out by one end side thereof from a slit formed in one end portion side of the “U” shape; a first frame that is provided extending in a width direction of the slit on the one end side of the second input/output portion; and a pair of second frames that are respectively provided on two end portion sides of the slit in the body, are able to protrude/retract from/to one side portion of the body provided with the slit in a manner similar to that of a telescope or a retractable ladder of a ladder truck, the two end portions of the frame being coupled between protruding side end portions.

With the configuration described above, in the wristwatch type information terminal device, the watch dial portion provided on the front plane of the body serves as the first input/output portion, and the long film-shaped second input/output portion, which realizes a portion of display and/or input operations, can be drawn out and used from the one side portion of the body other than the portions thereof to which a band is attached. Specifically, the body is formed as straightly as is possible in the circumferential direction of the wrist, and an inner portion of the body on the back side (under side) of the first input/output portion is provided with a storage portion that is substantially formed in a “U” shape overall in the lengthwise direction of the arm and forms a continuous bend in the circumferential direction, and the second input/output portion is bent into a “U” shape and housed in the bend of the storage unit. Thus, one end portion of the “U” shape is continuous with one side portion of the body and is formed as a slit therein, and the second input/output portion can be drawn out by one end (leading end) side thereof from the slit.

Furthermore, in order to support the long film-shaped second input/output portion, the first frame is provided extending in the width direction of the slit on the one end (leading end) side of the second input/output portion, and in order to support both ends of the first frame, the pair of second frames can protrude from, and retract to, the two end portion sides of the slit of the body in a manner similar to that of a telescope or the retractable ladder of a ladder truck.

Accordingly, the film-shaped second input/output portion can be smoothly deployed and housed without being folded. Thus, in a state in which the film-shaped second input/output portion is extended in a band-like shape above the palm or the back of the hand (when drawn out towards the finger-side), or over the arm (when drawn out towards the elbow-side), the film-shaped second input/output portion can realize high-level functionality and/or multi-functionality as an information terminal device by realizing a portion of display and/or input operations as the information terminal device.

Also, with the wristwatch type information terminal device of the present invention, the display of the second input/output portion is realized with electronic paper.

With the configuration described above, the electronic paper is thin and flexible. Accordingly, this is suitable as a film-shaped input/output portion that can be drawn through the slit and extended from a state in which the film-shaped input/output portion is bent into a “U” shape inside of the storage portion.

Furthermore, with the wristwatch type information terminal device of the present invention, the display of the second input/output portion is realized with a resin substrate organic EL film display.

With the configuration described above, a resin substrate organic EL film display is thinner and more flexible than other organic EL film displays. Accordingly, this is suitable as a film-shaped input/output portion that can be drawn through the slit and extended from a state in which the film-shaped input/output portion is bent into a “U” shape inside of the storage portion.

Also, with the wristwatch type information terminal device of the present invention, the application program selection screen is displayed on the first input/output portion, and the content of the application program that has been selected and initiated on the selection screen is displayed on the second input/output portion.

With the configuration described above, the application program selection screen, such as the icons, is displayed on the small sized first input/output portion at the watch dial portion of the body, with the detailed content of the selected application program displayed on the large second input/output portion, and therefore the information terminal device can handle a wide range of application programs despite being a wristwatch type information terminal device.

Furthermore, with the wristwatch type information terminal device of the present invention, the other end side of the long film-shaped second input/output portion is provided with the wheel that has a diameter larger than the width of the slit and that slides in the bend.

With the configuration described above, the wheel makes it possible to guide the other end portion of the second input/output portion and stop the second input/output portion from coming loose from the slit. Note that it is not absolutely necessary for the wheel to rotate, and a ball that does not become caught in the bent portion of the “U” shaped bent portion may also be used.

Also, with the wristwatch type information terminal device of the present invention, the retractable side end portion of the leading-end stage frame of the multi-stage second frame is coupled to the elastic member that is used to draw back the second frames.

According to the configuration described above, in order for the multi-stage second frames, which can protrude and retract in a similar manner to that of a telescope or the retractable ladder of a ladder truck, to be retracted (stored) after the second input/output portion is used, the retracting side end portion of the leading-end stage frame (second stage frame) is coupled to the elastic member that is made of rubber, a spring, or the like and is used to draw back the second frames. Furthermore, the locking means is provided so that the long film-shaped second input/output portion is not drawn into the housing portion due to the biasing force from the elastic member when the second input/output portion is completely drawn out.

Accordingly, if the second stage is fully retracted (stored), all of the stages are automatically drawn in (stored), and it is therefore possible to improve operability.

### INDUSTRIAL APPLICABILITY

In the wristwatch type information terminal device according to the present invention, for example, a storage tube is provided in one side portion of the body, the film-shaped information terminal device is stored in the storage tube in a wound up state, and the information terminal device realizes a portion of display and/or input operations in a state in which the input/output portion is pulled out and extended in a band-like shape over the palm or the back of the hand, and therefore the information terminal device can realize high-level functionality and/or multi-functionality, and is therefore favorable.

1. A wristwatch type information terminal device, comprising:
a storage tube provided on one side portion of a body; and
a film-shaped input and output portion that is configured to be stored in a wound up state in the storage tube, is configured to be extended by being drawn out from a slit formed in the storage tube in an axial direction of the storage tube, and, wherein in an extended state of the input and output portion at least one of: the input and output portion comprises a portion of a display of an information terminal device and input operations of the information terminal device are performed through the input and output portion.

2. The information terminal device according to claim 1, wherein the display of the input and output portion comprises electronic paper.

3. The information terminal device according to claim 1, wherein the display of the input and output portion comprises a resin substrate organic EL film display.

4. The information terminal device according to claim 1, wherein a selection screen for an application program is displayed on the body, and content of the application program selected and initiated on the selection screen is displayed on the input and output portion.

5. The information terminal device according to claim 1, wherein the film-shaped input and output portion is one of lined with, or enclosed in a frame of, a shape-memory alloy.

6. The information terminal device according to claim 1, wherein the storage tube and the input and output portion that is configured to be stored in the storage tube removably attaches to the one side portion of the body.

7. A wristwatch type information terminal device, comprising:
an input and output portion that is elongated and film-shaped, wherein at least one of: the input and output portion is comprised in a display of an information terminal device and input operations of the information terminal device are performed through the input and output portion;
a body comprising a housing portion whose front face supports the input and output portion from a back surface thereof, wherein the housing portion allows the input and output portion to be drawn out from one side surface of the body, and bends the input and output portion in a lengthwise direction thereof and houses the bent input/output portion therein;
a drum that is provided in the housing portion, can roll in the lengthwise direction, and is configured to have the input and output portion wound around an outer periphery thereof;
a biasing means configured to apply a tensile force to the drum in a direction in which the wound input and output portion is drawn in;
an arc-shaped guiding means that is provided in the body and is configured to guide the input/output portion from the housing portion towards the front face; and
a locking means configured to prevent the input and output portion from being drawn in due to the biasing means, in a state in which a base end portion of the input and output portion is drawn out from the housing portion via the guiding means until the base end portion faces a front side.

8. The information terminal device according to claim 7, wherein a window frame that forms an open window for exposing the input and output portion is provided in the front face, the window frame is not provided on the one side surface, and the drawn out input and output portion forms a continuous screen from a base end portion side to a free end portion side.

9. The information terminal device according to claim 7, wherein the drum is one of a plurality of drums that are provided spaced apart from each other in a thickness direction of the body.

10. A wristwatch type information terminal device comprising:
a first input and output portion that is provided at a front face of a body, wherein at least one of: the first input and output portion is comprised in a display of an information terminal device and input operations of the information terminal device are performed through the first input and output portion;
a second input and output portion that is elongated and film-shaped, wherein at least one of: the second input and output portion is comprised in portion of the display and input operations of the information terminal device are performed through the input and output portion;
a storage portion that is provided in the body on a back side (underside) of the first input and output portion, has an substantially U-shaped bend in a cross-sectional view in a lengthwise direction of an arm of a user, is configured to house the second input and output portion in the bend, and enables the second input and output portion to be drawn out by one end side thereof from a slit formed in one end portion side of the U-shaped bend;
a first frame that extends in a width direction of the slit on the one end side of the second input and output portion; and
a pair of second frames that are respectively provided on two end portion sides of the slit in the body, are able to protrude and retract from and into one side portion of the body provided with the slit, the two end portions of the frame being coupled between protruding side end portions.

11. The information terminal device according to claim 10, wherein the display of the second input and output portion comprises electronic paper.

12. The information terminal device according to claim 10, wherein the display of the second input and output portion comprises a resin substrate organic EL film display.

13. The information terminal device according to claim 10, wherein a selection screen for an application program is displayed on the first input and output portion, and content of the application program selected and initiated on the selection screen is displayed on the second input and output portion.

14. The information terminal device according to claim 10, wherein another end side of the second input and output portion comprises a wheel whose diameter is larger than the width of the slit and is configured to slide in the bend.

15. The information terminal device according to claim 10, wherein the second frames have a multi-stage configuration, and elastic members that are used to draw back the second frames are coupled to retracting-side end portions of leading end stage frames of the second frames.

16. The information terminal device according to claim 8, wherein the drum is one of a plurality of the drums that are provided spaced apart from each other in a thickness direction of the body.

17. The information terminal device according to claim 7, wherein the display of the input and output portion comprises electronic paper.

18. The information terminal device according to claim 7, wherein the display of the input and output portion comprises with a resin substrate organic EL film display.

19. The information terminal device according to claim 10, wherein the pair of second frames are able to protrude and retract from and into one side portion of the body provided with the slit in a manner similar to that of a telescope.

20. The information terminal device according to claim 10, wherein the pair of second frames are able to protrude and retract from and into one side portion of the body provided with the slit in a manner similar to that of a retractable ladder of a ladder truck.
